(19) United States
(12) Patent Application Publication
(10) Pub. No.: US 2014/0379411 A1
(43) Pub. Date: Dec. 25, 2014

(54) SYSTEM AND METHOD FOR INFORMATION TECHNOLOGY RESOURCE PLANNING

(71) Applicant: Hartford Fire Insurance Company, Hartford, CT (US)

(72) Inventor: John J. Earle, Hadley, MA (US)

(21) Appl. No.: 13/921,811

(22) Filed: Jun. 19, 2013

(51) Int. Cl. G06Q 10/06

(52) U.S. Cl. CPC G06Q 10/06315; G06Q 40/08
USPC 705/7.25

(57) ABSTRACT

Methods and apparatus for information technology (IT) resource planning are disclosed. The method including storing in a memory device, a forecast of IT resource requirements, wherein the forecast includes a plurality of data entries associated with projected IT resource requests. The method further including receiving, by a receiver, a request for at least one additional IT resource and determining, by a processor, whether the requested at least on additional IT resource is associated one of the plurality of data entries. If the requested at least one additional IT resource is associated with one of the plurality of data entries, transmitting, by a transmitter, a request to order the at least one additional IT resource and notifying at least one predetermined user of the order. If the requested at least one additional IT resource is not associated with one of the plurality of data entries, sending a notification to at least one predetermined user requesting approval of the request. The method further including updating, by the processor, the forecast of IT resource requirements.

### BACKGROUND

Insurance companies, like other large corporations, include many offices located over many geographic areas. One insurance company may offer products for multiple lines of business and employ thousands of employees. The information technology demands for such a large organization can be immense. Each line of business may need its own network infrastructure, each office may need a separate intranet and each user may need a personal computer. To properly run a company, many types of information technology (IT) resources are needed, including computer hardware, software, electronics, semiconductors, internet, telecom equipment, e-commerce and computer services, disaster recovery, data security, and infrastructure security, just to name a few.

IT resources represent large capital investments for a corporation. However, unlike most aspects of a budget, management of IT resources is typically fractured and not managed at the enterprise level, but rather at the local business office level. Necessarily, an IT department must be responsive to the needs of the various users spread throughout an organization. For the financial services/insurance industry, IT resources allocation may have special requirements related to security of confidential client data. This data often must be made anonymous and subsequently disposed of in a specific manner. Accordingly, the management of IT resources for the financial services industry offers unique challenges.

IT capacity resource allocation requires balancing supply against demand of equipment and services versus cost. The distributed nature of today's networks only increases the complexity in resource management. To be more efficient and adapt to an electronic based work place, the allocation of IT resources to the business demands of a financial services company, a more comprehensive tool is required.

### SUMMARY

Methods and apparatus for information technology (IT) resource planning for an insurance company are disclosed. The method including storing in a memory device, a forecast of IT resource requirements of the insurance company, wherein the forecast includes a plurality of data entries associated with projected IT resource requests. The method further including receiving, by a receiver, a request for at least one additional IT resource and determining, by a processor, whether the requested at least on additional IT resource is associated one of the plurality of data entries. If the requested at least one additional IT resource is associated with one of the plurality of data entries, transmitting, by a transmitter, a request to order the at least one additional IT resource and notifying at least one predetermined user of the order. If the requested at least one additional IT resource is not associated with one of the plurality of data entries, sending a notification to at least one predetermined user requesting approval of the request. The method further including updating, by the processor, the forecast of IT resource requirements.

### BRIEF DESCRIPTION OF THE DRAWINGS

A more detailed understanding may be had from the following description, given by way of example in conjunction with the accompanying drawings wherein:

FIG. 1 shows an example architecture that may be used for the information technology resource planning;

FIG. 2 shows a flow diagram for a method for information technology resource planning;

FIG. 3 shows a block diagram of the functional blocks of the pipeline controller;

FIG. 4 is an example web page for interfacing with the pipeline controller;

FIG. 5 is an example web page for forecasting IT resource allocation;

FIG. 6 is an example web page for viewing the results created by the pipeline controller;

FIG. 7 shows an example computing device that may be used to implement features described herein with reference to FIGS. 1-6; and

FIG. 8 is a tablet computer that is a more specific example of the computing device of FIG. 7.

### DETAILED DESCRIPTION

Disclosed herein are processor-executable methods, computing systems, and related technologies for information technology resource planning for an insurance company. An enterprise level business may comprise many groups; each group may include an affiliated company, offices, and departments, and be located in physically separate locations. In general, because of confidentiality requirements associated with the insurance industry, there may be statutory privacy and security requirements. Also, each of these groups may have specialized IT resource needs, for example, multiple computers, printers, IP phones, software licenses, vendors, IT maintenance requirements. The systems and method described herein allow for a central pipeline controller to forecast and manage IT resource demands at an enterprise level using supply chain management techniques. The pipeline controller serve as a central location may manage and store company wide level projection information for IT resources and may permit or deny requests for IT resources. The pipeline controller may receive requests for IT resources from any affiliated group. Based on previously projected IT requests, the pipeline controller 110 may access the finance and management module to determine whether budget resources exist to purchase the requested resources. If the budget resources are available, the pipeline controller may directly purchase the IT resources by accessing a vendor module. The pipeline controller may then update its own projections, providing an improved forecast and it may also notify the requester of the status of the request. The updated forecasting information may be stored and managed in a database for use by interactive and non-interactive systems. The pipeline controller 110 may further be configured to conditionally approve a request, conditional on predetermined criteria.

A user, operating a user device may access the pipeline controller 110 and receive real-time updated forecasts and projections.

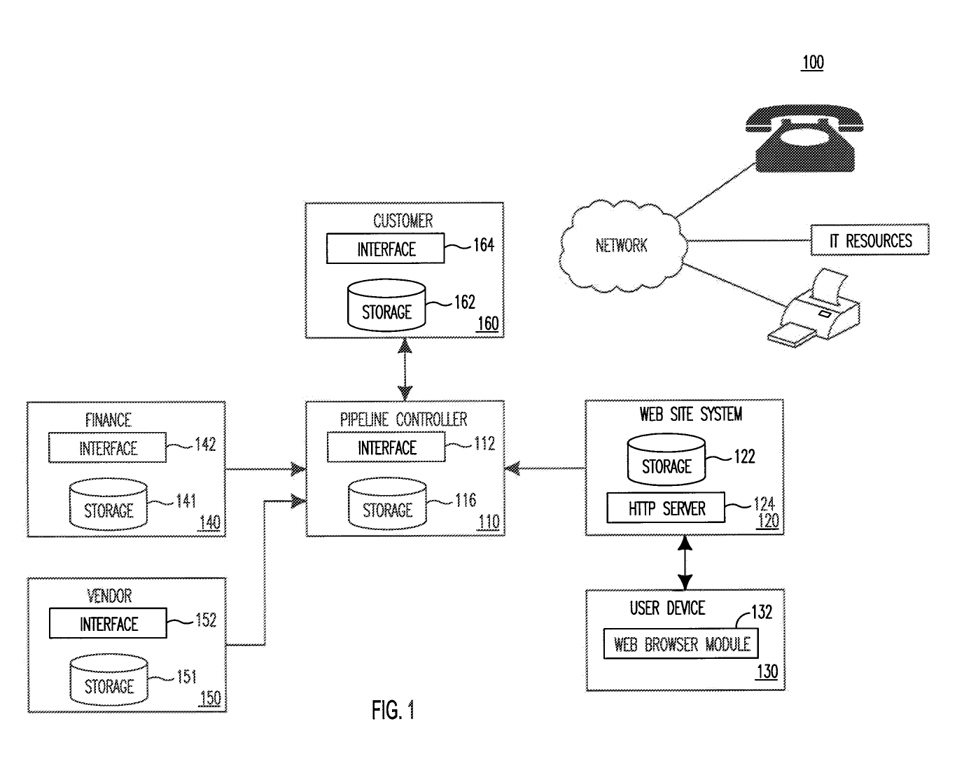

FIG. 1 shows an example architecture 100 that may be used for managing information technology resource planning. The example architecture 100 includes a pipeline controller 110, web site system 120, user device 130, a finance module 140, a product/supplier system 150, and a customer module 170, which are all connected by one or more networks.

In the example architecture 100 of FIG. 1, the pipeline controller 110, web site system 120, finance module 140, and customer module 170 are under the control of an insurance company. A user, using a user device 130 may view the real-time projections and forecasts generated by the pipeline controller. As will be described in greater detail hereafter, the system 100 may be configured to: consolidate demand forecast data into single repository; provide visibility into real-time forecast data; provide basis for capacity planning with service towers; provide basis for demand tracking and approval; provide platform for reporting and analysis; provide a clear understanding of process; and provide a common approach to ensure consistent demand forecast data across the enterprise. The web site system 120 provides a web site that may be accessed by a user operating the user device 130. Using this web site, a user operating a user device 130 may view monitor and track IT resource, supply, demand and expenditures at an enterprise level on a real time basis. The pipeline controller 110 may be configured to send notifications to various users concerning reports related to IT resource allocation. These notifications may be through any number of available communication channels (e.g. email, SMS, social media, or the web site).

The finance module 140 includes an interface 142 and a financial and management database 141. The finance module 140 acts as a central repository for financial information. This may include income tax information, financial statements, books of account, payroll information, banking information, sales records, purchase records, expense records, fixed assets, depreciation policies, personnel records, and corporate documents. The finance module 140 may also include budget information. The finance module 140 may receive and consolidate updates from any/all of business units associated with the company and is typically accessed by the CFO. The finance module 140 may receive user input from input devices (not depicted) that are included in or connected to the finance module 140. These input devices may include, for example, a keyboard, a mouse, or a touch screen, which provide data that indicates the input to the finance module 140. The database 141 may be spread across one or more computer-readable media, and may be or include one or more relational databases, hierarchical databases, object-oriented databases, one or more flat files, one or more spreadsheets, and/or one or more structured files. The database 141 may be managed by one or more database management systems (not depicted), which may be based on a technology such as Microsoft SQL Server, MySQL, PostgreSQL, Oracle Relational Database Management System (RDBMS), a NoSQL database technology, and/or any other appropriate technology. Communication between the finance module 140 and the other elements in the example architecture 100 of FIG. 1 may be performed via the interface module 142 in the finance module 140. Communication between the interface module 142 and the other elements in the example architecture 100 may be performed using technologies such as Simple Object Access Protocol (SOAP), Representational State Transfer (REST), other appropriate Service Oriented Architecture (SOA) technology or web services technology, and/or other appropriate technology.

The vendor system 150 is a computer or other type of data processing device or computing device that manages transactions for producers/suppliers that provide IT resources. For example, the vendor system 150 may be associated with a third party that licenses software for use by the insurance company. While the example shown in FIG. 1 includes only one vendor system 150, the pipeline controller 110 may be configured to communicate with multiple producers/suppliers that supply a range of IT resources. The vendor system 150 may include a database 141 for storing purchasing/delivery information associated with the product(s) offered by the vendor. The pipeline controller 110 may communicate with the vendor system 150 and order IT resources, it may check on the status of orders, and perform other managerial operations. The vendor system 150 includes an interface 152 for interfacing with the other elements in the example architecture 100. The vendor system 150 may receive user input from input devices (not depicted) that are included in or connected to the vendor system 150. These input devices may include, for example, a keyboard, a mouse, or a touch screen, which provide data that indicates the input to the interface 152. Alternatively, vendor system 150 may receive requests directly via a web page operated by the interface 152. In this example, a user using a user device may order IT resources and enter a code associated with the insurance company. The Vendor may communicate this request information to the pipeline controller 110, which may treat the request as a request received from the customer module 170.

The customer module 160 is a computer or other type of data processing device or computing device operated by a group associated with the insurance company. For example, the consumer customer module may be located at a remote office associated with the insurance company. The customer module manages or communicates with a plurality of IT resources. The customer module is used to communicate IT resource requests, IT resource statuses, and other IT resource information associated with the group. While the example shown in FIG. 1 includes only one customer module 160, the pipeline controller 110 may be configured to communicate with multiple customers that require a range of IT resources. The customer module 160 may include a database 162 for storing purchase/delivery information associated with the particular group. The database 162 may also include templates for submitting requests to the pipeline controller 110. The templates may be in any electronic format, such as Word, PDF, email, html, etc. The pipeline controller 110 may communicate with the customer module 160 and satisfy requests for IT resources, it may check on the operational status of IT resources, and perform other managerial operations. The customer module 160 includes an interface 164 for interfacing with the other elements in the example architecture 100. The customer module 160 may receive user input from input devices (not depicted) that are included in or connected to the customer module 160. These input devices may include, for example, a keyboard, a mouse, or a touch screen, which provide data that indicates the input to the interface 164. Alternatively, customer module 160 may receive input directly via a web page operated by the interface 164 or from any of the associated IT resources. In this example, an IT resource that is in need of repair or replacement may communicate with the customer module 160 that it is in need of repair or replacement via the network. The customer module may be configured to receive this information and generate a request based on a stored request template, and transmit the request to the pipeline controller 110.

The pipeline controller 110 includes an interface 112 and a database 116. The pipeline controller 110 acts as a central controller and monitor for the system 100. The pipeline controller 110 may consolidate all IT resource information for a company and provide the visibility to a user. The pipeline controller 110 watches and controls every IT resource transaction and is updated in real-time. Based on this information, the pipeline controller 110 may be configured to provide real-time forecasting of IT resource supply and demand. Each IT resource controlled by the company is stored in the database 116 as a line item. This information may not only include standard information (e.g. unit name etc.) but it may include additional information, such as physical dimensions and space required, for servers it may include the amount data capacity. Additionally, each line item may be linked with multiple line items. For example, for each laptop computer line item, there may be multiple linked line items, including a service contract, software licenses, peripheral hardware, etc. This allows holistic IT resource forecasting. The pipeline controller 110 allows a user to control IT resource allocation according to a true supply chain factory model. For example, the pipeline controller may generate projected supply and demand reports that are focused purely on server storage space supply and demand. The pipeline controller 110 may communicate with the finance module 140 and the vendor system 150 and update costs and budget information on a real-time basis. The pipeline controller 110 may receive user input from input devices (not depicted) that are included in or connected to the pipeline controller 110. These input devices may include, for example, a keyboard, a mouse, or a touch screen, which provide data that indicates the input to the pipeline controller 110. The database 116 may be spread across one or more computer-readable media, and may be or include one or more relational databases, hierarchical databases, object-oriented databases, one or more flat files, one or more spreadsheets, and/or one or more structured files. The database 116 may be managed by one or more database management systems (not depicted), which may be based on a technology such as Microsoft SQL Server, MySQL, PostgreSQL, Oracle Relational Database Management System (RDBMS), a NoSQL database technology, and/or any other appropriate technology. Communication between the pipeline controller 110 and the other elements in the example architecture 100 of FIG. 1 may be performed via the interface module 112. Communication between the interface module 112 and the other elements in the example architecture 100 may be performed using technologies such as Simple Object Access Protocol (SOAP), Representational State Transfer (REST), other appropriate Service Oriented Architecture (SOA) technology or web services technology, and/or other appropriate technology.

The web site system 120 provides a web site that may be accessed by a user (typically a CFO or a CTO) operating the user device 130. The web site system 120 includes a HyperText Transfer Protocol (HTTP) server module 124 and a database 122. The HTTP server module 124 may implement the HTTP protocol, and may communicate HyperText Markup Language (HTML) pages and related data from the web site to/from the user device 130 using HTTP. The web site system 120 may be connected to one or more private or public networks (such as the Internet), via which the web site system 120 communicates with devices such as the user device 130. The web site system 120 may generate one or more web pages that communication setting information, may communicate the web pages to the user device 130, and may receive responsive information from the user device 130. The responsive information may include information indicating that a request for additional IT resources has been received, or provide updated projection information.

The HTTP server module 124 in the web site system 120 may be, for example, an Apache HTTP server, a Sun-ONE Web Server, a Microsoft Internet Information Services (IIS) server, and/or may be based on any other appropriate HTTP server technology. The web site system 120 may also include one or more additional components or modules (not depicted), such as one or more load balancers, firewall devices, routers, switches, and devices that handle power backup and data redundancy.

The user device 130 is, for example, a cellular phone, a desktop computer, a laptop computer, a tablet computer, or any other appropriate computing device. The user device 130 includes a web browser module 132, which may communicate data related to the web site to/from the HTTP server module 124 in the web site system 120. The web browser module 132 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 132 may implement Rich Internet Application (RIA) and/or multimedia technologies such as Adobe Flash, Microsoft Silverlight, and/or other technologies. The web browser module 132 may implement RIA and/or multimedia technologies using one or web browser plug-in modules (such as, for example, an Adobe Flash or Microsoft Silverlight plug-in), and/or using one or more sub-modules within the web browser module 132 itself. The web browser module 132 may display data on one or more display devices (not depicted) that are included in or connected to the user device 130, such as a liquid crystal display (LCD) display or monitor. The user device 130 may receive input from the user of the user device 130 from input devices (not depicted) that are included in or connected to the user device 130, such as a keyboard, a mouse, or a touch screen, and provide data that indicates the input to the web browser module 132.

The example architecture 100 of FIG. 1 may also include one or more wired and/or wireless networks (not depicted), via which communications between the elements 110, 120, 130, 140, 150, and 160 in the example architecture 100 may take place. The networks may be private or public networks, and/or may include the Internet. In one example deployment scenario, pipeline controller 110, the web site system 120, finance module 140, and customer module 160 may communicate via one or more private networks that are under the control of the insurance company, while the user device 130 and the vendor system 150 may communicate with the web site system 120 via the Internet.

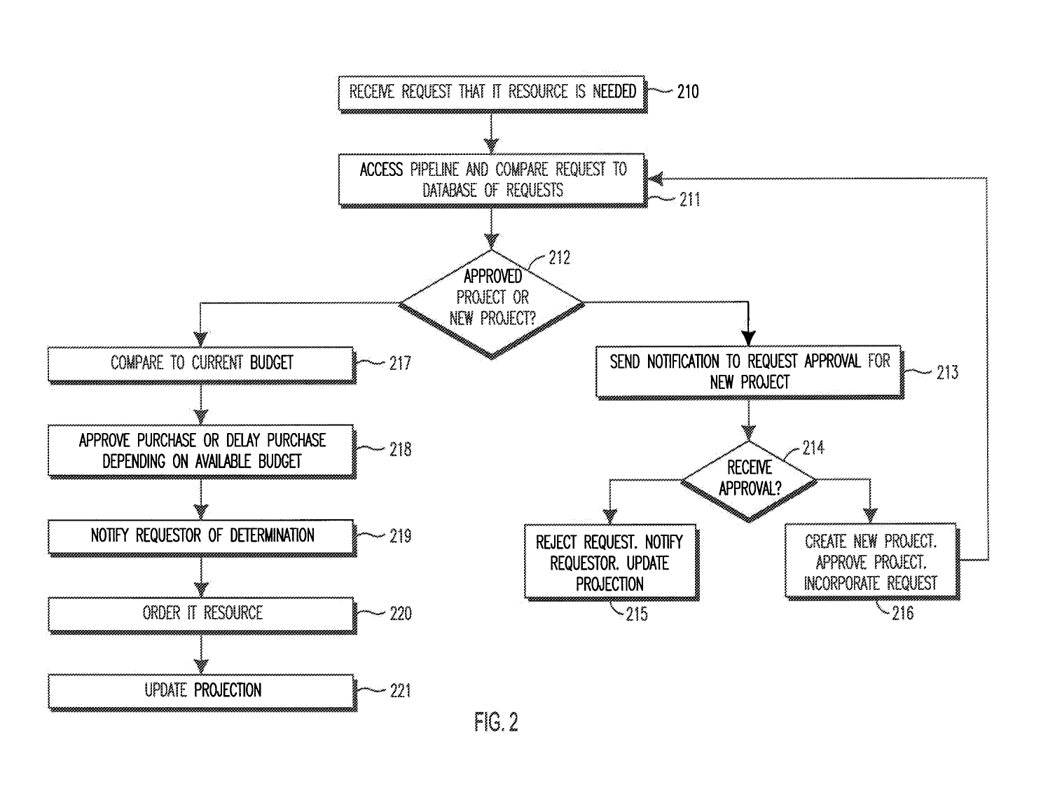

Each or any combination of the modules shown in FIG. 1 may be implemented as one or more software modules, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 1, these modules may perform functionality described herein with reference to FIGS. 2-5.

FIG. 2 shows an example use case for method 205 for information technology resource planning at an enterprise level. The system implementing the method may be preconfigured with an annual budget, a list of projects which may require IT resources, and projected costs for IT resources based on the received information. Based on this budget and list of projects, the system may be configured to produce a forecasting document, indicating expected expenditures for IT resources. The method 200 of FIG. 2 begins with the pipeline controller 110 receiving a request for IT resources (210). As described above, the request may be received in the form of an electronic template. This request may be received from the customer module 160, from a vendor system 150, from a user device 130 or it may be directly entered into the pipeline controller 110 via an input device associated with the pipeline controller 110. As an example, a software license associated with a particular office may be expiring. This may prompt the customer module 160 to generate a request for either a new software or renewal of the software license. The request is entered into a template that may be stored, for example, at the customer module 160 or on the web site system 120. In another scenario, a user may directly access a vendor system 150, for example, through their web site. The user may purchase, for example 100 new laptops and enter a code associated with the insurance business. The vendor system 150 may submit a request to the pipeline controller 110 in response to this order.

Once the request is received, an entry is created. Each entry may be assigned metadata, including, but not limited to a pipeline ID, a reference ID, a transaction date, a status, a transaction type, user, and category. A pipeline ID may be a unique identifier assigned to each line item request. A reference ID may be a group level identifier assigned to each line item. The transaction date may be a data and time stamp indicating when the line-item was created or modified. The status indicator may describe the state of the transaction. The transaction type may indicate the type of transaction. The User field is automatically populated with the end-users network ID. The transaction category is a categorization based on the type of transaction carried out.

Table 1 shows an example list of status indicators that may be used.

| Status | Definition |
|---|---|
| Pending | Demand that requires approval by an Account Manager (or |
| | equivalent). |
| Approved | Demand that has been approved by an Account Manager (or |
| | equivalent). |
| Released | APPROVED demand which has been formally requested |
| | systems. Short for “Released for Provisioning”. |
| Completed | Demand that has been provisioned and is reported in the Billing |
| | Metrics (actuals). |
| Rejected | Denied request for NEW demand. |
| Canceled | Demand which is no longer required. |

Table 2 shows a list of example transaction types.

| Transaction Type | Definition |
|---|---|
| New Demand | Un-planned unforecasted demand is needed |
| Re-forecast | Approved demand requires change to a quantity, |
| | seasonality and/or attribute |
| Approve | Approve a line item which is in pending status |
| Commit Demand | Commit a demand associated with a detailed estimate |
| Release | Approved demand is ready for provisioning |
| Edit | Modification of a line item is required |
| Cancel | Cancel a line item which is no longer needed |
| Complete | Complete a line item which is already in a released status |
| Reject | Reject a request in a pending state |

Table 3 shows a list of example transaction categories.

| Transaction Category | Definition |
|---|---|
| CMPLT | Transaction record that has been COMPLETED |
| | or fulfilled. |
| CNCL | Transaction record that has been CANCELED. |
| NEW | Transaction inserting NEW demand records |
| NEW (a) | Transaction to APPROVE NEW demand records. |
| RF | Transaction to REFORECAST an existing record. |
| RF (a) | Transaction to APPROVE a Reforecast record. |
| ProdOrd (rel) | Transaction RELEASING a record for provisioning. |
| PrdOrd (de) | Transaction COMMITTING demand quantities |
| | associated with a Detailed Estimate. |

Referring back to FIG. 2, after receiving a request, the pipeline controller 110 determines compares the metadata associated with the request with previously stored information (211). The pipeline controller 110 then determines whether the request is a new demand or related to a request that was either planned or forecasted (212).

If the request is a new request, the metadata associated with the request is set to pending. The pipeline controller 110 sends a notification to predetermined users notifying them of the new request (213). The pipeline controller determines whether a response is received to this request (214. If no response is received in response to this request in a predetermined time, the request is marked as rejected. If a response is received from a predetermined user, and the request is rejected, the status is updated, and the requestor is notified of the update in status (215). If the pipeline controller 110 receives a response approving the request, the metadata is updated (216), the system then returns to step 211 to assure the request was not simultaneously entered by multiple sources.

If the request is an approved request, it may still be possible that the budget cannot support additional purchases at that time. Accordingly, the pipeline controller 110 checks the budget in real-time to determine whether financial resources are in place for the particular expenditure. In one embodiment, the pipeline controller 110 may access the finance module 140 and request an up-to-date financial snap shot (217). The financial snap-shot may be compared with updated forecasts to determine whether to release the request. Based on this determination, the pipeline controller 110 may release the request, or delay the request for example by delaying the order by 6 months (218). The pipeline controller 110 may then notify the requestor of the determination (219). The pipeline controller may then order the IT resource (220). For example, the pipeline controller 110 may communicate directly with a vendor system 150 to purchase the resources and update the finance module 140 of the purchase. Finally, the pipeline controller 110 may update the forecast based on the order (221).

The pipeline controller 110 may further be configured to provisionally approve a request. For example, an approval for a new server may be conditioned on current server utilization and/or speed. Accordingly, if the pipeline controller 110 determines that the current server's performance drops below a predetermined level, the pipeline controller 110 may satisfy the condition and authorize the purchase of a new server.

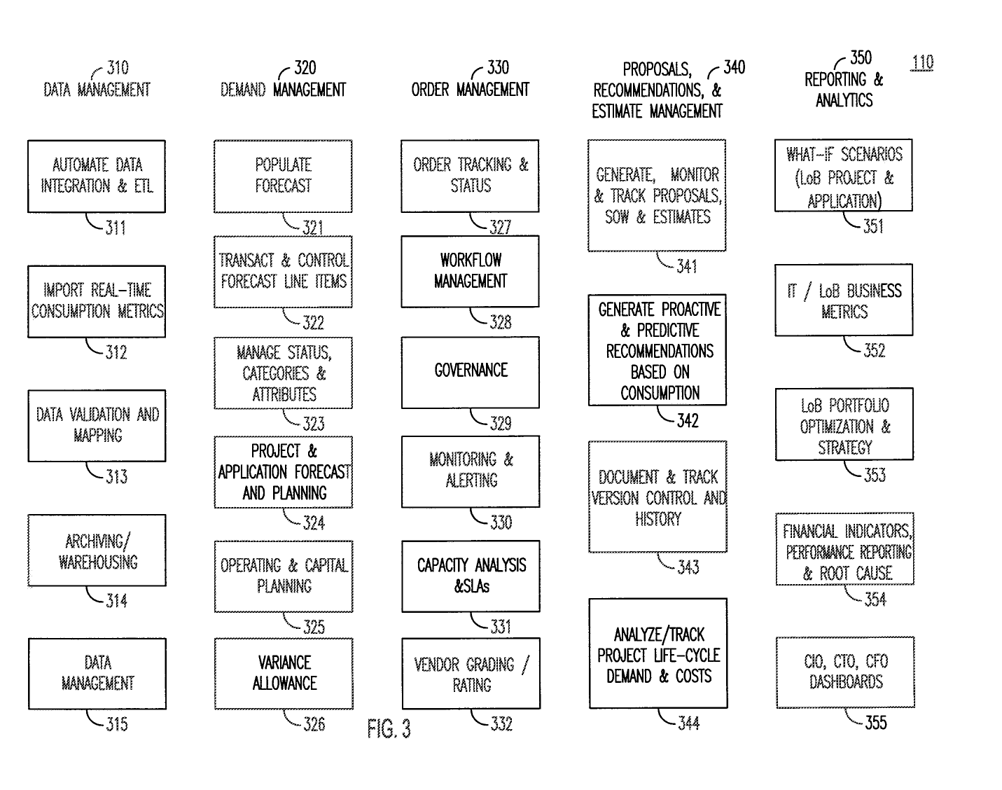

FIG. 3 shows a block diagram of the functional blocks of the pipeline controller 110 shown in FIG. 2. The pipeline controller 110 may comprise a data management module 310, a demand management module 320, an order management module 330, a proposals management module 340, and a reporting and analytics module 350. The pipeline controller serves as a central location to track inventory, allocation, and utilization. The pipeline controller 110 may not only track conventional metrics such as overall costs of goods, but may also track storage capacity, speed, product life span etc. The pipeline controller 110 may be configured to track and analyze non-tangible metrics in the same manner as tangible metrics to generate a more accurate demand forecast.

The data management module 310 facilitates the data management functions of the pipeline controller 110. The data management module 310 may comprise an automate data integration and extract transfer and load (ETL) unit 311, an import real-time consumption metrics unit 312, a data validation and mapping unit 313, an archiving/warehousing unit 314, and a data management unit 315. The automate data integration and ETL unit may serve as a central location to coordinate receipt of data. This may include data received internally from a user, it may be received internally from a machine-to-machine process, or it may be received externally from third party vendors or other users operating a user device 132. This data may be provided to the import real-time consumption metrics unit 312 which may track memory usage, physical space usage, IT resource supply usage (e.g. paper, toner, replacement parts) as well as any other IT resource. The data management module 310 stores this information, in a database, that allows for wear housing and archiving. The data management module 310 may also track installing and decommissioning of servers.

Because databases associated with the financial services industry may contain patient sensitive data, they must be installed, maintained, and decommissioned securely. Decommissioning a server may require more costs than installing a new server. The pipeline controller 110 is configured to assist in this process by identifying data to be disposed of and configured to enact procedures to decommission a server and to manage the costs associated with such a decommission.

The demand management module 320 facilitates the demand management functions of the pipeline controller 110. The demand management module 320 may comprise a populate forecast unit 321, a transact and control forecast line items unit 322, a manage status, categories and attributes unit 323, project & application forecast and planning unit 324, an operating & capital planning unit 325, and a variance analysis unit 326. The demand management module 320 is configured to determine, manage and forecast the demand of IT resources. The populate forecast unit 321 may be configured to use a software based algorithm to generate a probabilistic forecast based on the received statistics and industry benchmarks. This information may be generated on a line item basis by the transact and control forecast line items unit 322. The demand management module 320 may further be configured to generate forecast models based on historical data, price, technology advances, and industry changes. The demand management module 320 may apply principles from manufacturing to the financial services industry. This may provide the user with efficient supply chain management of IT resources from a central location. As is described below, certain requests for IT resources may require a user operating a user device to approve of a purchase. The demand management module 320 is configured to update forecasts automatically based on the approval status of an IT request. This update may be performed in real-time.

The order management module 330 facilitates the order management functionality of the pipeline controller 110. The order management module 330 may comprise an order tracking and status unit 331, work-flow management unit 332, a governance unit 333, a monitoring & alerting unit 334, a capacity analysis and SLAs unit 335, and a vendor grading/rating unit 336. The order management module 330 performs order receipt, processing and tracking for the pipeline controller 110. The order management module 330 may track IT resource descriptions, attributes, locations, quantities, availability and sourcing. It may track vendors, purchasing, and receiving, order processing, and financials. The order tracking and status unit 327 tracks the orders and the status of the order. The order tracking and status unit 327 may be configured to track each product as a whole as well as a conglomerate of a bill of materials, which accounts for the components that comprise the whole. This allows for the tracking of replacement parts. The work-flow management unit 328 stores and tracks IT resource order workflow, tracking each resource. The governance unit 329 stores business rules and decision making information. The capacity analysis and SLA unit monitors IT resource capacity including speed, memory etc. as well as service level agreements. The vendor grading/rating unit 332 grades each vendor based on price metrics, service metrics, reliability metrics and other metrics that may provide a holistic evaluation of the cost of goods and services.

Information from the order management module 330 may be fed into the demand management module 320 for improved forecasting. For example, a particular office may order an IT resource (e.g. printer ink) on a weekly basis, while another office of equal size may order the same resource on a monthly basis. This information may be transmitted to the other modules 310, 320, 340, and 350 to update forecasts and demand projections for the IT resource based for related LOBs etc. This functionality may be automated, wherein a network connected device may notify the pipeline controller 110, through a network connection, that a resource is running low. For example, in the hypothetical above, a printer or copier may notify the pipeline controller 110 that a resource such as ink or toner are low, which may then allow the order management module 330 to initiate an order of the resource. This may allow real-time and predictive supply chain management for all IT resources and related office supplies.

The order management module 330 may further be configured to operate on a consumption based model. The order management module 330, in addition to receiving orders from users may be configured to monitor consumption of resources and generate requests for resources when resource utilization reaches a predetermined percentage.

The proposals management module 340 facilitates proposals, recommendations and estimate management functionality of the pipeline controller 110. The proposals management module 340 may comprise a first unit 341 to generate, monitor and track proposals, statements of work (SOW) and estimates, a second unit 342 to generate proactive and predictive recommendations based on consumption, a document and track version control and history unit 343, and a unit 344 to analyze/track project life-cycle demand and costs. The proposals management module 340 receives a proposal and accesses the other modules in the pipeline controller 110 to generate predictive recommendations. Each proposal is assigned a unique identifier, and it is tracked as a project to analyze the life cycle of a project. The proposals management module 340 may access industry benchmarks and determine the type of IT resources that may be allocated and revise a proposal. The revised proposal may be transmitted back to the user for review. The proposals management module 340 generates estimates for use in forecasting costs.

The reporting and analytics module 350 facilitates reporting the reporting and analytic functionality of the pipeline controller 110. The reporting and analytics module 350 may a “what-if” scenarios unit 351 (e.g. for line of business, projects and applications, an IT/LOB metrics unit 352, a LOB portfolio optimization and strategy unit 353, a financial indicators, performance reporting and root cause unit 354, and a CIO, CTO, CFO Dashboards unit 355. The “what-if” scenarios unit 351 allows a user to generate scenarios to forecast cost/utilization scenarios. This functionality allows for operational planning. Based on the results of this unit 351, quotes may be generated for actual purchasing. The IT/LOB metrics unit 352 generates metrics for each line of business. The LOB portfolio optimization and strategy unit 353 may allow for different allocation strategies based on the particular needs of a line of business. For example, a business insurance office may need different equipment than worker's compensation office. The LOB portfolio optimization and strategy unit 353 may access the IT/LOB metrics unit 352 to determine these optimizations. The pipeline controller 110 may be configured to use this LOB information to transfer assets between different LOBs or offices. For example, a server or laptop may be determined unacceptable for a particular line of business based on the determined metrics. However, it may be suitable for another line of business. Therefore the proposals management module 340 may access the information from the reporting and analytics module 350 and recommend transferring assets from one LOB to another.

The financial indicators unit 354 generates an assessment of financial performance tracked over time and benchmarked against other LOBs or businesses. For example, the financial indicators unit may generate results based on measuring resource sufficiency, operating results, financial assets, and debt management. The financial indicators unit 354 also generates performance reports on the capabilities and performance of the IT resources. The financial indicators unit 354 also has a root cause determination functionality to identify root causes in the acquisition, utilization, and disposal of IT resources.

The CIO, CTO, CFO dashboard unit 355 provides customizable dashboards for each level of user. While three users (CIO, CTO, and CFO) are named, the unit 355 may produce dashboard for other levels of users as well. For example, the CIO, CTO, CFO dashboard unit 355 may provide a high level financial presentation for a CFO and a more technological presentation for a CTO. The unit 355 may be configured to adapt the reports based on the authorizations and permissions for a particular user. Because this may include sensitive customer insurance data, safeguards are installed to prevent unauthorized access to sensitive records.

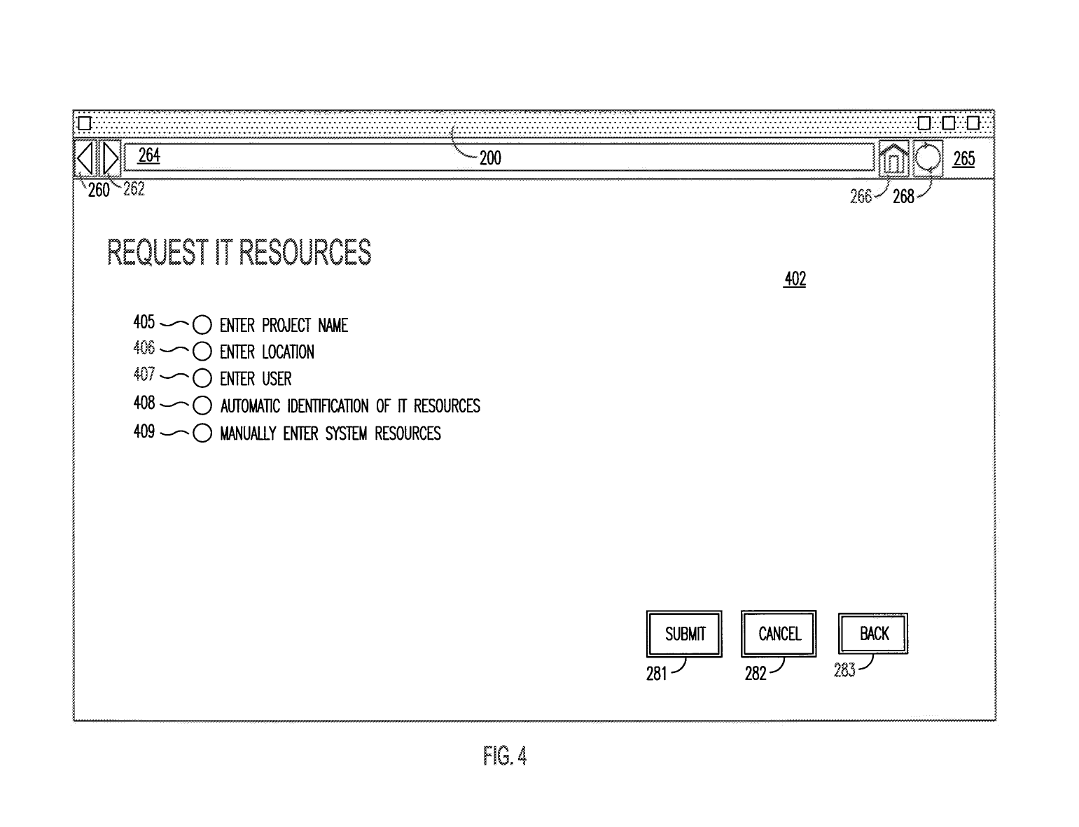

FIGS. 4-6 show example web pages that may be displayed by the web browser module 132. As will be described in detail below, the web pages may include display elements which allow the user of the client device 130 to interface with the system 100 and view forecasting information. The web pages may be included in a web browser window 200 that is displayed and managed by the web browser module 132. The web pages may include data received by the web browser module 132 from the web site system 120. The web pages may include information technology resource planning.

The web browser window 200 may include a control area 265 that includes a back button 260, forward button 262, address field 264, home button 266, and refresh button 268. The control area 265 may also include one or more additional control elements (not depicted). The user of the user device 130 may select the control elements 260, 262, 264, 266, 268 in the control area 265. The selection may be performed, for example, by the user clicking a mouse or providing input via keyboard, touch screen, and/or other type of input device. When one of the elements 260, 262, 264, 266, 268 is selected, the web browser module 132 may perform an action that corresponds to the selected element. For example, when the refresh button 268 is selected, the web browser module 132 may refresh the page currently viewed in the web browser window 200.

FIG. 4 is an example web page 402 for interfacing with the pipeline controller 110. As shown in FIG. 4, the web page 402 may include a question and multiple input fields 405-409 in the form of radio buttons. As the user provides input into the input fields 405-409, the web browser module 132 may store one or more data structures (“response data”) that reflect the selections made in the input fields 405-409. Further, as the selections are updated, the web browser module 132 may update the web page 402 to indicate additional or more specific questions that may be associated with the selections. As an example, if the user selects input area 405, the user may be presented with a drop down list to select a previously entered project name or the user may select “other” and enter a new project. The user may also select input area 406 which may provide the user with a drop down list of locations. This selection may be used to narrow down previously entered projects or to classify a new project. As noted above, each request is associated with a User ID, and input area 407 prompts the user to enter this User ID. Another feature of the system 100 is that it may detect IT resources so that it may remotely monitor them to determine when servicing, replacement, and/or decommissioning are required. By selecting input area 408, the pipeline controller 110 is able to access a group's network to locate IT that is connected over the internet. Input area 409 prompts the user to manually enter any IT resources.

At any time, while viewing the web page 402 of FIG. 4, the user may select the cancel button 232, which cancels any pending action and returns the user to a homepage (not shown). Selecting the previous button 234 allows the user to return to the previous screen, while remaining in a session. Selecting the next button 236 enters the selections which are then transmitted to the web site system 120. If there are no errors in the transmission, the web browser module 132 is directed to a subsequent web page.

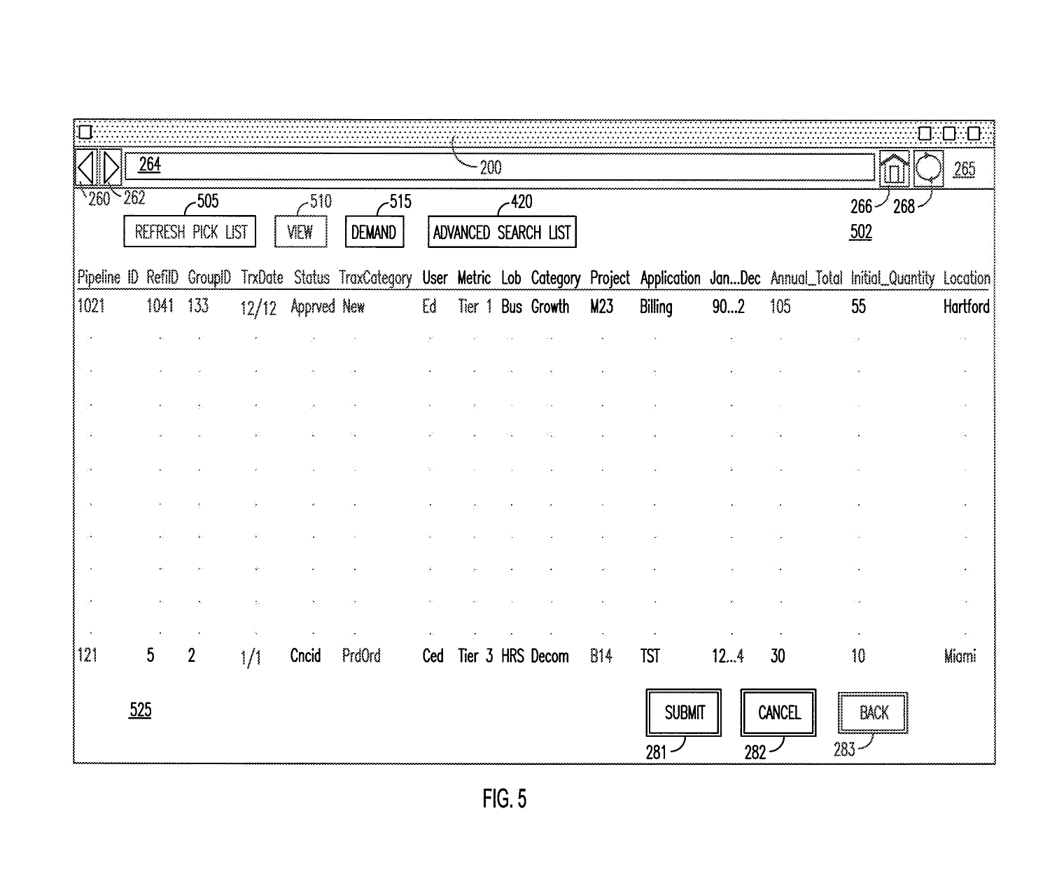

FIG. 5 is an example web page 502 for forecasting IT resource allocation. As shown in FIG. 5, the web page 502 may include multiple interactive input fields 505, 510, 515, 520, and 525. As the user device 130 receives input for the input fields, the web browser module 132 may store one or more data structures (“response data”) that reflect the selections made in the input fields. Further, as the selections are updated, the web browser module 132 may update the web page 502 to indicate additional or more specific questions that may be associated with the selections.

Selecting input area 505 initiates a request to update pick list data. As this system 100 may oversee IT resource allocation for large organizations, this information may be updated frequently.

Selecting input area 510 may activate a drop-down menu. The drop down menu may allow the user to initiate, for example, the following functions: clear filters, view fields, clear markers, and full page view.

Selecting input area 515 activate a drop down menu that provides a list of each of the Transaction Types (TrxTypes) offered by the pipeline controller 110. The user of the user device 130 may select any cell in the row/record for adjusting or referencing, and select from the list of items in the drop down menu.

Input area 520 initiates a program to enhance your pipeline search capabilities. Selecting input area 520 bring ups an Advanced Search window allowing the user to add a valid PipelineID in the “Find PipelineID” input box. The user may select “Filter on GrpID,” select the “search” button and the program web page module 154 presents only those records with a GrpID associated with the PipelineID. This subset of records provides the history of transactions associated with the original PipelineID parent record.

The display shown on FIG. 5 may be tailored to the user accessing the pipeline controller 110. As an example, the web page 502 shown in FIG. 5 includes metrics directed at cost an inventor. However, if the user accessing the pipeline controller 110 is a CTO, the web page 502 may include different metrics focused on technology utilization (e.g. server space, speed, etc.). Additionally, the pipeline controller 110 may be configured with different permission levels. Accordingly, a manager of a remote branch may have access to metrics concerning only the remote branch or some subset of the total available data. This may allow different users access to different portions of data based on their assigned user privileges.

At any time, while viewing the web page 402 of FIG. 5, the user may select the cancel button 232, which cancels any pending action and returns the user to a homepage (not shown). Selecting the previous button 234 allows the user to return to the previous screen, while remaining in a session. Selecting the next button 236 enters the selections which are then transmitted to the web site system 120. If there are no errors in the transmission, the web browser module 132 is directed to a subsequent web page.

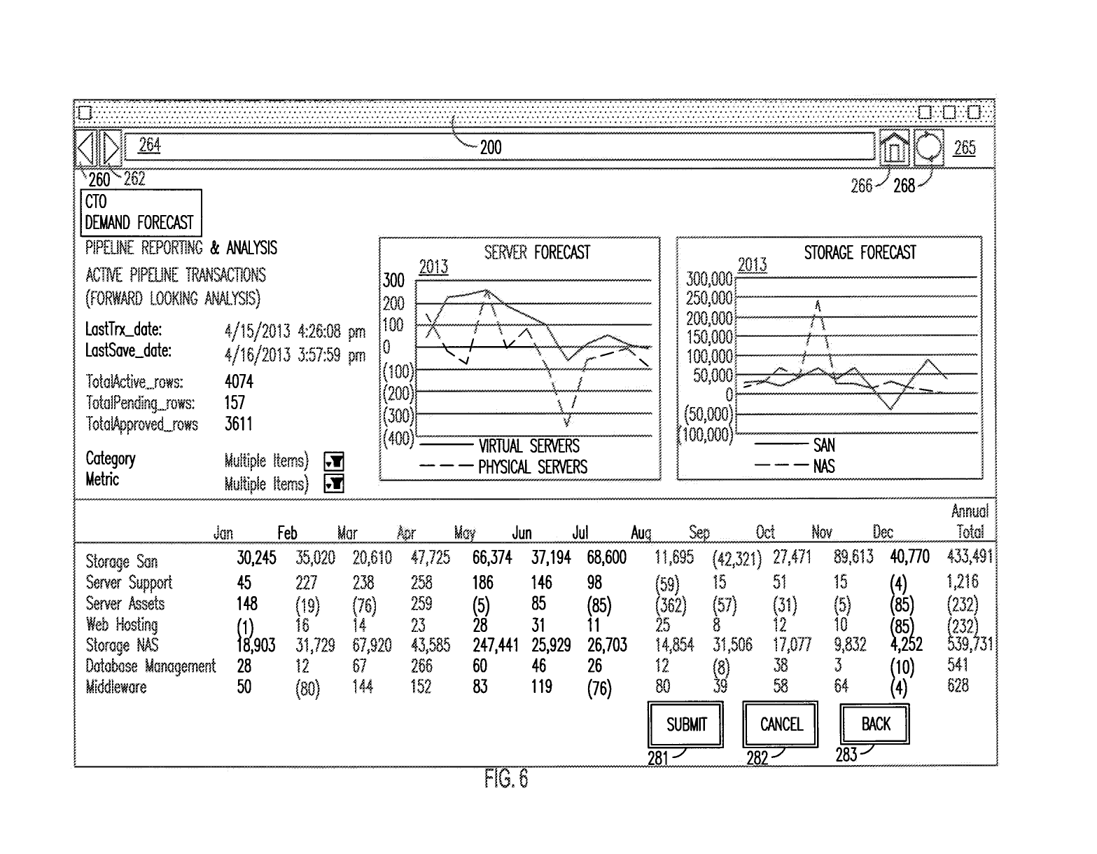

FIG. 6 is an example web page 602 for viewing the results created by the pipeline controller 110. As shown in FIG. 6, the web page 602 may include a multiple input fields and display areas. Web page 602 may include a results information field 625 which displays the time and date of the latest update to the results. Because the pipeline controller 110 can update the results real-time, it is important that the user be able to identify the accuracy of the information. A user using user device 130 may select input area 605 which may then refresh web page 602 with updated information. Input field 610 allows the user to select which information is to be displayed on web page 602. For example, the user may select particular categories or offices to monitor. By entering a selection into input area 610, the web browser module 132 may identify metadata associated with the input and then request information from the pipeline controller 110 based on that metadata. Display area 615 and 620 are numerical and graphical results, respectively. The results may include comparison data between projected IT resource use and actual IT resource use as well as a comparison of previous years. Additionally, the user may update the projections by either entering numerical data into display area 615 or selecting a portion of the graph in display area 620 and shifting it. These inputs may then be communicated back to the pipeline controller to adjust projections. As the user provides input into the input fields or display areas, the web browser module 132 may store one or more data structures (“response data”) that reflect the selections made. Further, as the selections are updated, the web browser module 132 may update the web page 602 to indicate additional or more specific questions that may be associated with the selections.

Additionally, the input and display fields in FIG. 6 may be used to create “what if” scenarios. For example, the user may enter an expenditure of 100 laptops and view and updated forecast. If the updated forecast is acceptable and the item is within the approved budget or forecast, the user may submit the update and it may be converted into an order.

In another embodiment, based on the forecast, the pipeline controller 110 may be configured to analyze the projected line items and propose alternate line items or suggested timelines for purchase.

In short, the pipeline controller 110 offers a true supply chain and factory model. The pipeline controller 110 allows real supply chain value, for example, if you have 300 million in demand, it allows you to react to demand and better control value.

Additionally, the pipeline controller 110 is configured to identify linked items based on the metadata associated with each IT resource. For example, if a physical server is aging, it may be decommissioned. The pipeline controller 110 is configured to identify the software licenses, physical footprint, service contracts associated with the server. The pipeline controller 110 may further be configured to update the projected costs/cost savings associated with terminating software licenses and service contracts etc.

At any time, while viewing the web page 502 of FIG. 6, the user may select the cancel button 232, which cancels any pending action and returns the user to a homepage (not shown). Selecting the previous button 234 allows the user to return to the previous screen, while remaining in a session. Selecting the next button 236 enters the selections which are then transmitted to the web site system 120. If there are no errors in the transmission, the web browser module 132 is directed to a subsequent web page.

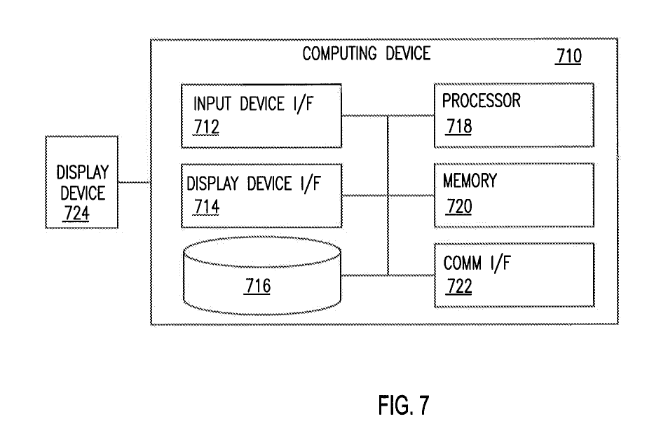

FIG. 7 shows an example computing device 710 that may be used to implement features describe above with reference to FIGS. 1-6. The computing device 710 includes a processor 718, memory device 720, communication interface 722, peripheral device interface 712, display device interface 714, and storage device 716. FIG. 7 also shows a display device 724, which may be coupled to or included within the computing device 710.

The memory device 720 may be or include a device such as a Dynamic Random Access Memory (D-RAM), Static RAM (S-RAM), or other RAM or a flash memory. The storage device 716 may be or include a hard disk, a magneto-optical medium, an optical medium such as a CD-ROM, a digital versatile disk (DVDs), or Blu-Ray disc (BD), or other type of device for electronic data storage.

The communication interface 722 may be, for example, a communications port, a wired transceiver, a wireless transceiver, and/or a network card. The communication interface 722 may be capable of communicating using technologies such as Ethernet, fiber optics, microwave, xDSL (Digital Subscriber Line), Wireless Local Area Network (WLAN) technology, wireless cellular technology, and/or any other appropriate technology.

The peripheral device interface 712 may be an interface configured to communicate with one or more peripheral devices. The peripheral device interface 712 may operate using a technology such as Universal Serial Bus (USB), PS/2, Bluetooth, infrared, serial port, parallel port, and/or other appropriate technology. The peripheral device interface 712 may, for example, receive input data from an input device such as a keyboard, a mouse, a trackball, a touch screen, a touch pad, a stylus pad, and/or other device. Alternatively or additionally, the peripheral device interface 712 may communicate output data to a printer that is attached to the computing device 710 via the peripheral device interface 712.

The display device interface 714 may be an interface configured to communicate data to display device 724. The display device 724 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 714 may operate using technology such as Video Graphics Array (VGA), Super VGA (S-VGA), Digital Visual Interface (DVI), High-Definition Multimedia Interface (HDMI), or other appropriate technology. The display device interface 714 may communicate display data from the processor 718 to the display device 724 for display by the display device 724. As shown in FIG. 7, the display device 724 may be external to the computing device 710, and coupled to the computing device 710 via the display device interface 714. Alternatively, the display device 724 may be included in the computing device 700.

An instance of the computing device 710 of FIG. 7 may be configured to perform any feature or any combination of features described above as performed by the user device 130. In such an instance, the memory device 720 and/or the storage device 716 may store instructions which, when executed by the processor 718, cause the processor 718 to perform any feature or any combination of features described above as performed by the web browser module 132. Alternatively or additionally, in such an instance, each or any of the features described above as performed by the web browser module 132 may be performed by the processor 718 in conjunction with the memory device 720, communication interface 722, peripheral device interface 712, display device interface 714, and/or storage device 716.

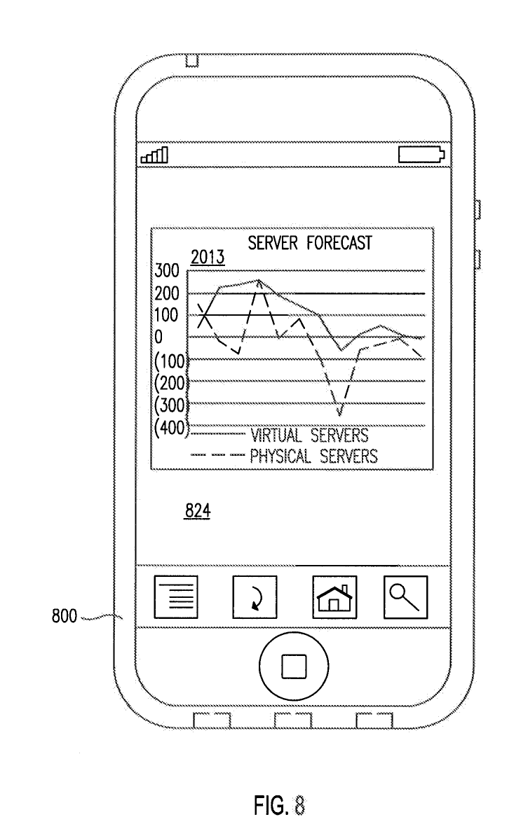

FIG. 8 shows a tablet computer 800 that is a more specific example of the computing device 710 of FIG. 7. The tablet computer 800 may include a processor (not depicted), memory device (not depicted), communication interface (not depicted), peripheral device interface (not depicted), display device interface (not depicted), storage device (not depicted), and touch screen display 824, which may possess characteristics of the processor 718, memory device 720, communication interface 722, peripheral device interface 712, display device interface 714, storage device 716, and display device 724, respectively, as described above with reference to FIG. 7. The touch screen display 824 may receive user input using technology such as, for example, resistive sensing technology, capacitive sensing technology, optical sensing technology, or any other appropriate touch-sensing technology. As shown in FIG. 8, the touch screen display 824 may display information described above with reference to FIGS. 1-7. The touch screen display 824 may receive input from a user of the tablet computer 800, for filling in a notification/alert document shown in the touch screen display 824.

Referring again to FIG. 7, an instance of the computing device 710 may alternatively or additionally be configured to perform any feature or any combination of features described above as performed by the pipeline controller 110, the finance module 140, the vendor system 150 and the customer module 160. In such an instance, the memory device 720 and/or the storage device 716 may store instructions which, when executed by the processor 718, cause the processor 718 to perform any feature or any combination of features. In such an instance, the processor 718 may perform the feature or combination of features in conjunction with the memory device 720, communication interface 722, peripheral device interface 712, display device interface 714, and/or storage device 716.

Alternatively or additionally, an instance of the computing device 710 may be configured to perform any feature or any combination of features described above as performed by the user device 130. In such an instance, the memory device 720 and/or the storage device 716 may store instructions which, when executed by the processor 718, cause the processor 718 to perform any feature or any combination of features described above as performed by the user device 130. In such an instance, the processor 718 may perform the feature or combination of features in conjunction with the memory device 720, communication interface 722, peripheral device interface 712, display device interface 714, and/or storage device 716.

Alternatively or additionally, an instance of the computing device 710 may be configured to perform any feature or any combination of features described above as performed by the web site system 120. In such an instance, the memory device 720 and/or the storage device 716 may store instructions which, when executed by the processor 718, cause the processor 718 to perform any feature or any combination of features described above as performed by the user device 130, web browser module 132 and/or the HTTP server module 124. In such an instance, the processor 718 may perform the feature or combination of features in conjunction with the memory device 720, communication interface 722, peripheral device interface 712, display device interface 714, and/or storage device 716.

Although FIG. 77 shows that the computing device 710 includes a single processor 718, single memory device 720, single communication interface 722, single peripheral device interface 712, single display device interface 714, and single storage device 716, the computing device may include multiples of each or any combination of these components 718, 720, 722, 712, 714, 716, and may be configured to perform, mutatis mutandis, analogous functionality to that described above.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

Although the methods and features described above with reference to FIGS. 2-8 are described above as performed using the example architecture 100 of FIG. 1, the methods and features described above may be performed, mutatis mutandis, using any appropriate architecture and/or computing environment. Although features and elements are described above in particular combinations, each feature or element can be used alone or in any combination with or without the other features and elements. For example, each feature or element as described above with reference to FIGS. 1-8 may be used alone without the other features and elements or in various combinations with or without other features and elements. Sub-elements of the methods and features described above with reference to FIGS. 1-8 may be performed in any arbitrary order (including concurrently), in any combination or sub-combination.

What is claimed is:

1. A method for information technology (IT) resource planning for an insurance company coordinating between a vendor, a customer, and a business center by a central controller, the method comprising:
storing, in a memory device, a forecast of IT resource requirements of the insurance company, wherein the forecast includes a plurality of data entries associated with projected IT resource requests;
receiving, by a receiver, a request for at least one additional IT resource;
determining, by a processor, whether the requested at least on additional IT resource is associated one of the plurality of data entries; and
if the requested at least one additional IT resource is associated with one of the plurality of data entries, transmitting, by a transmitter, a request to order the at least one additional IT resource and notifying at least one predetermined user of the order;
if the requested at least one additional IT resource is not associated with one of the plurality of data entries, sending a notification to at least one predetermined user requesting approval of the request; and
updating, by the processor, the forecast of IT resource requirements.

2. The method of claim 1, wherein the request for additional IT resource is received from a second processor associated with a customer module.

3. The method of claim 2, wherein the second processor is configured to determine that an IT resource needs replacement and generate the request.

4. The method of claim 1, further comprising receiving input from a user device;
generating a hypothetical forecast, based on the received input;
generating display information comparing hypothetical forecast to the forecast; and
transmitting display information to the user device.

5. The method of claim 1, wherein the request for at least one additional resource is received from a vendor system.

6. The method of claim 1, wherein the request for at least one additional resource is received from a user device.

7. The method of claim 1, wherein each of the plurality of data entries include metadata, the metadata including at least one of a pipeline ID, a reference ID, a transaction date, a status, a transaction type, user, and a category.

8. The method of claim 1, wherein the forecast is based at least in part on projected data storage demand.

9. A system information technology (IT) resource planning for an insurance company by a central controller, the system comprising:
a memory device configured to store a forecast of IT resource requirements of the insurance company, wherein the forecast includes a plurality of data entries associated with projected IT resource requests;
a receiver configured to receive a request for at least one additional IT resource;
a processor configured to determine whether the requested at least on additional IT resource is associated one of the plurality of data entries; and
a transmitter configured to request to order the at least one additional IT resource and notifying at least one predetermined user of the order, if the requested at least one additional IT resource is associated with one of the plurality of data entries; and the transmitter configured to transmit a notification to at least one predetermined user requesting approval of the request if the requested at least one additional IT resource is not associated with one of the plurality of data entries; and
the processor further configured to update the forecast of IT resource requirements.

10. The system of claim 9, wherein the request for additional IT resource is received from a second processor associated with a customer module.

11. The system of claim 10, wherein the second processor is configured to determine that an IT resource needs replacement and generate the request.

12. The system of claim 9, wherein the receiver is further configured to receive input from a user device;
the processor configured to generate a hypothetical forecast, based on the received input and to generate display information comparing hypothetical forecast to the forecast; and
the transmitter further configured to transmit display information to the user device.

13. The system of claim 9, wherein the request for at least one additional resource is received from a vendor system.

14. The system of claim 9, wherein the request for at least one additional resource is received from a user device.

15. The system of claim 9, wherein each of the plurality of data entries include metadata, the metadata including at least one of a pipeline ID, a reference ID, a transaction date, a status, a transaction type, user, and a category.

16. The system of claim 9, wherein the forecast is based at least in part on projected data storage demand.

17. A non-transitory computer-readable storage medium storing a set of instructions for execution by a general purpose computer to perform a method for information technology (IT) resource planning for an insurance company coordinating between a vendor, a customer, and a business center by a central controller, the instructions adapted for:
storing, in a memory device, a forecast of IT resource requirements of the insurance company, wherein the forecast includes a plurality of data entries associated with projected IT resource requests;
receiving, by a receiver, a request for at least one additional IT resource;
determining, by a processor, whether the requested at least on additional IT resource is associated one of the plurality of data entries; and
if the requested at least one additional IT resource is associated with one of the plurality of data entries, transmitting, by a transmitter, a request to order the at least one additional IT resource and notifying at least one predetermined user of the order;
if the requested at least one additional IT resource is not associated with one of the plurality of data entries, sending a notification to at least one predetermined user requesting approval of the request; and
updating, by the processor, the forecast of IT resource requirements.
